(19) United States
(12) Patent Application Publication
(10) Pub. No.: US 2026/0106527 A1
(43) Pub. Date: Apr. 16, 2026

(54) ELECTRIC MACHINE

(71) Applicant: Schaeffler Technologies AG & Co. KG, Herzogenaurach (DE)

(72) Inventor: Martin Häßler, Graben-Neudorf (DE)

(73) Assignee: Schaeffler Technologies AG & Co. KG, Herzogenaurach (DE)

(21) Appl. No.: 19/115,805

(22) PCT Filed: Aug. 31, 2023
(86) PCT No.: PCT/DE2023/100633

§ 371 Date: Mar. 27, 2025

(30) Foreign Application Priority Data
Sep. 28, 2022 (DE) 10 2022 124 964.6

(51) Int. Cl. H02K 21/02

(52) U.S. Cl. CPC H02K 21/024

(57) ABSTRACT

A rotor has at least one first rotor body with a first group of permanent magnets and a second rotor body with a second group of permanent magnets. The first and the second rotor bodies are rotated relative to each other about a common rotational axis against the effect of a first torsional stiffness by a mechanical field-attenuation mechanism. The field-attenuation mechanism includes a lever element. The first rotor body is coupled to a first lever section, and the second rotor body is coupled to a second lever section of the lever element. The first and second lever sections are arranged on opposite sides of the lever such that by tilting the lever element, the first and the second rotor bodies are rotated relative to each other in a targeted manner to produce a desired adjustment of the mechanical field-attenuation mechanism.

### CROSS-REFERENCE TO RELATED APPLICATIONS

This application is the United States National Phase of PCT Application PCT/DE2023/100633, filed Aug. 31, 2023, which claims priority to German Application 10 2022 124 964.6, filed Sep. 28, 2022. The disclosures of the above applications are incorporated herein by reference.

### TECHNICAL FIELD

The present disclosure relates to an electric machine, for use within a drive train of a hybrid or fully electrically powered motor vehicle. The electric machine includes a stator and a rotor separated from the stator by an air gap. The rotor has at least a first rotor body with a first group of permanent magnets and a second rotor body with a second group of permanent magnets, where the first rotor body and the second rotor body can be rotated relative to one another, counter to the effect of a first torsional stiffness, about a common axis of rotation by way of a mechanical field-attenuation mechanism.

### BACKGROUND

Electric machines are subject to losses during operation due to magnetic reversal, which are grouped together as iron losses and reduce the machine efficiency. In mobile applications, low efficiency of the electric machine means a reduced range of the vehicle or increased demand for battery capacity. It is therefore an ongoing goal, especially in mobile applications with purely electric drive, to minimize the iron losses described.

An example of such an electric machine with iron losses, as it can be used within a drive train of a hybrid or fully electrically powered motor vehicle, is what is termed the permanently excited synchronous machine. Due to its high power density compared to other types of machines, it is preferred for use in the field of electromobility, where the available installation space is often a limiting factor. The excitation field of the machine is usually generated by permanent magnets that are arranged in the rotor of the machine. In a permanently excited synchronous machine, it is possible to dispense with a slip ring contact which is necessary in electrically excited synchronous machines to supply power to an excitation coil arranged on the rotor.

However, a disadvantage of permanent excitation is that the excitation field cannot be easily modified. In principle, a synchronous machine can be operated beyond its rated speed by controlling what is termed the field-attenuation range. In this range, the machine is operated at its maximum rated power, with the torque delivered by the machine decreasing as the speed increases. Electrically excited synchronous machines can be operated very easily in the field-attenuation range by reducing the excitation current. Even in the case of permanent magnet machines, there are known ways of generating an air gap field component by way of a suitable current supply to the stator of the machine, which counteracts the excitation field generated by the permanent magnets and thus weakens or attenuates it. However, such control of the machine causes increased losses such that the machine can only be operated with a reduced efficiency in this range.

An effective method for reducing iron losses in electric machines is to deliberately weaken or attenuate the magnetic field between stator and rotor for operating points with high speeds, since the losses due to high-frequency magnetic reversal are lower with a weaker magnetic field. Mechanical as well as electrical approaches for targeted field attenuation also exist. From the patent specifications U.S. Pat. No. 5,8211,710, FR2831345, EP1085644, EP11867030, DE1012011708670, DE1012016103470, CN104600929 and CN105449969, a rotor of a radial flux machine is known which is divided in a manner perpendicular to the rotational axis into several rotor discs equipped with permanent magnets and which can be rotated relative to one another. Depending on the relative rotation between the rotor discs, the rotor provides the full magnetic field in a position with the magnetic poles aligned in the axial direction and an attenuated magnetic field in a position rotated relative to this. Active or passive mechanisms are described which claim to be able to switch between these two positions depending on the rotor speed or torque and thus enable more efficient operation of the electric machine over the entire engine characteristic map.

DE 10 12021 101 898 describes an arrangement in which the rotor of a radial flux machine is divided into two partial rotors, the individual rotor discs of which alternate in the axial direction. One part of the rotor is directly connected to the rotor shaft, the other part is connected to the rotor shaft in a torque-transmitting manner via a torsional stiffness. The torsional stiffness is selected in such a way that at low torque the partial rotors are in a torsional position with an attenuated magnetic field and at high torque the partial rotors are in a torsional position with a full magnetic field. DE 10 12021 101 904 claims a structurally designed mechanical module that can be introduced into the interior of the permanent magnet-equipped rotor discs, creates the described connections of the partial rotors to the rotor shaft, and allows for a movement characteristic to be defined via the torsional stiffness, which is implemented with springs and roller-equipped cam drives.

All previously mentioned passive solutions, which use a torque as a sensor variable to trigger a relative rotation between two partial rotors against a torsional stiffness, assume that the total electromagnetic torque generated by the stator current supply in the case of the initially field-attenuated position with non-aligned magnetic poles is simply distributed between the two partial rotors, approximately according to their share of the total length and according to their respective phase position with respect to the stator field, regardless of the presence of the other partial rotor. Only then could a partial torque proportional to the total torque be easily directed against a torsional stiffness between the partial rotors or one of the partial rotors and the rotor shaft and bring about the desired rotation with increasing torque into the position with a full magnetic field with aligned magnetic poles. However, tests and modeling by the applicant have shown that the actual situation is far more complicated.

Even in the de-energized case, there are interactions between the rotor discs of the two partial rotors in the form of magnetic repulsion torques. The position with a full magnetic field and aligned magnetic poles represents a labile equilibrium with vanishing repulsion torque. As the rotation begins from this equilibrium position, a repulsion torque arises which increases with increasing rotation until it reaches a maximum and then decreases again with further rotation. The course of the repulsion torque over the angle of rotation within an electrical period, the height of the maximum, and the angle of rotation at which it occurs depend strongly on the chosen type of arrangement of the permanent magnets within the rotor discs. The course over an electrical period is fundamentally nonlinear.

In the case of the desired efficient stator current supply for different speeds, these magnetic repulsion torques increase in different ways depending on the speed, sometimes many times over. Overall, partial torques result which are in no case suitable to be easily directed against a torsional stiffness between the partial rotors or one of the partial rotors and the rotor shaft to cause a rotation of the partial rotors into the position with a full magnetic field, since they do not point in the right direction for this due to the high proportion of magnetic repulsion torques.

### SUMMARY

To represent a functional arrangement in the sense of the previously mentioned passive solutions for torque-adaptive field attenuation of the rotor of an electric machine, the disclosure provides an electric machine with an improved mechanical field attenuation, which also effectively converts the partial torques actually occurring on the rotor bodies for a desired movement and transfers them to the rotor shaft.

One aspect of the disclosure provides an electric machine, for use within a drive train of a hybrid or fully electrically powered motor vehicle. The electric machine includes a stator and a rotor separated from the stator by an air gap. The rotor has at least a first rotor body with a first group of permanent magnets and a second rotor body with a second group of permanent magnets. The first rotor body and the second rotor body can be rotated relative to one another, counter to the effect of a first torsional stiffness, about a common axis of rotation by way of a mechanical field-attenuation mechanism. The field-attenuation mechanism includes a lever element with a center of gravity, which can be pivoted about a tilting axis. The first rotor body can be coupled to a first lever section and the second rotor body can be coupled to a second lever section of the lever element and the first lever section and the second lever section are arranged on opposite sides of the lever such that the first rotor body and the second rotor body can be rotated relative to one another in a targeted manner by tilting the lever element for a desired movement of the mechanical field-attenuation mechanism, where the center of gravity of the lever element and the tilting axis of the lever element are spaced apart from one another when the electric machine is at a standstill.

This provides the advantage that an electric machine can be realized with a purely mechanical field-attenuation device, which reliably and cost-effectively adjusts the positions of permanent magnets within the rotor required for field attenuation as required, depending on the operating conditions of torque and speed. In principle, the disclosure thus also avoids the need for actuators to intervene on or in the rotor from the outside.

The centrifugal force acting under speed at the center of gravity of the lever interferes with the balance of forces and torques at the lever element and thus influences the movement behavior of the lever mechanism within the engine characteristic map. For example, an intended purely torque-dependent movement behavior could be disturbed by the effect of the centrifugal force. Conversely, a movement behavior that is simultaneously dependent on the speed and the torque can be targeted in order to achieve an even more efficient operation of the electric machine over the entire engine characteristic map. By adjusting the position of the center of gravity and the lever pivot axis, it is possible to account for different movement behaviors via torque and speed (in conjunction with other influences that will be explained in more detail below).

The position of the center of gravity and the lever tilting axis can be specifically determined, for example, by distributing the material within the lever element in a suitable way, such as by way of shaping, adding mass or removing material. The decisive factor for the tilting of the lever element and thus for the strength of the magnetic field in the associated position of the partial rotors (rotor bodies) is the balance of forces and torques at the lever element, which will be discussed in more detail below.

Another aspect of the proposed mechanical field attenuation is, among other things, the use of a lever at at least two points around the circumference within the rotor in order to transfer the partial torques of the two rotor bodies, for example, to a rotor shaft, with the simultaneous effect of torsional stiffness between the rotor bodies, where the mechanical field-attenuation mechanism has a plurality of lever elements, each of which is pivotally arranged in a distributed manner around the circumference of the rotor shaft.

The partial torques of the two rotor bodies act on the lever via the lever sections in such a way that the sum of the torques is transmitted to the rotor shaft, for example, and at the same time the two rotor bodies are pivoted against the torsional stiffness that exists between them, for example, to the position with a full magnetic field with aligned magnetic poles, by pivoting the lever. With the lever, the partial torques, which actually point in the wrong direction for this process, are converted into the target direction.

In some implementations, the electric machine can be designed as a rotary machine. In the case of electric machines designed as rotary machines, a distinction is drawn between radial flux machines and axial flux machines. A radial flux machine is characterized in that the magnetic field lines extend in the radial direction in the air gap formed between rotor and stator, while in the case of an axial flux machine the magnetic field lines extend in the axial direction in the air gap formed between rotor and stator. In the context of this disclosure, it is possible that the electric machine is configured as a radial flux machine or axial flux machine.

A rotor is the rotating (spinning) part of an electric machine. The rotor includes a rotor shaft and one or more rotor bodies formed of laminated rotor cores which are arranged on the rotor shaft in a non-rotatable manner. The rotor shaft can be hollow, which on the one hand results in weight savings and on the other hand allows the supply of lubricant or coolant to the rotor body.

A rotor body is understood to mean the rotor without a rotor shaft. The rotor body includes the laminated rotor core and the magnetic elements introduced into the pockets of the laminated rotor core or fixed circumferentially to the laminated rotor core, and any axial cover parts present for closing the pockets.

The permanent magnets may be inserted into the pockets of the rotor core. A single larger rotor magnet designed as a bar magnet or a plurality of smaller permanent magnetic elements may be provided for each pocket.

In some implementations, the rotor has a plurality of rotor bodies. For example, the rotor bodies are formed essentially of the same parts, such as identically. In some examples, the rotor bodies are formed from identical, such as essentially identical rotor laminations. The rotor bodies may therefore be formed from a laminated rotor core, which includes a plurality of laminated individual sheets or rotor laminations, usually made of electrical steel, which are layered and packaged one above the other to form a stack, what is termed the laminated rotor core. The individual sheets can be held together in the laminated rotor core by gluing, welding, or screwing. A laminated rotor core may also have permanent magnets that are inserted into the pockets of the laminated rotor core, or that are fixed circumferentially to the laminated rotor core.

In some implementations, a rotor shaft is coupled coaxially within the first rotor body and the second rotor body via the lever element in a torque-transmitting manner to the first rotor body and the second rotor body. In some examples, the lever element is pivotally mounted on the rotor shaft. This makes it possible to achieve a compact design for the mechanical field attenuation.

In some implementations, the lever element can extend in the radial direction into a first lever window of the first rotor body. The first lever window has a first lever contact section and a second lever contact section radially spaced therefrom, and the lever element can extend in the radial direction into a second lever window of the second rotor body. The second lever window has a first lever contact section and a second lever contact section radially spaced therefrom, where the lever element bears against the first lever contact section of the first lever window and against the second lever contact section of the second lever window in a first operating position and bears against the second lever contact section of the first lever window and against the first lever contact section of the second lever window in a second operating position.

In some implementation, the lever thus has three regions at different distances from the rotational axis of the rotor, in which it is in contact with the two rotor bodies as the two inputs for the torque and the rotor shaft as the output for the torque. This is another significant difference compared to the prior art, in which elements for transmitting the partial torques to the rotor shaft always have only one input and one output. The partial torques of the two rotor bodies act on the lever via the defined lever contact sections in such a way that the sum is transmitted to the rotor shaft and, at the same time, the two rotor bodies are pivoted against the torsional stiffness that exists between them, for example, to the position with a full magnetic field and aligned magnetic poles, by tilting the lever.

In some implementations, the first lever contact section is arranged radially below the second lever contact section of the first lever window and the first lever contact section is arranged radially below the second lever contact section of the second lever window.

In some examples, a larger torque, in terms of absolute value, is applied via the first lever element to the first lever contact section of the first lever window and to the first lever contact section of the second lever window than to the second lever section of the first lever window and the second lever contact section of the second lever window. In this regard, the lever is used to convert the partial torques, which actually point in the wrong direction for the mechanical movement process, into the direction required, by the larger of the two partial torques in terms of absolute value, which determines the direction of the total torque, acting radially further inwards on the lever than the smaller of the two partial torques.

In some implementations, the torsional stiffness is formed as a spring element, such as a compression spring or arc spring.

In some examples, the characteristic curve of the torsional stiffness is selected such that when a specified minimum torque is exceeded, the first rotor body and the second rotor body begin to rotate relative to one another from a position with maximum field attenuation and, when a specified maximum torque is reached and/or exceeded, they have completed a rotation relative to one another into a position with a full magnetic field. In this context, the characteristic curve of the torsional stiffness exhibits a bias torque.

In some implementations, the center of gravity of the lever element can lie below the tilting axis when the electric machine is at a standstill. If the center of gravity of the lever is thus moved radially further inwards than the lever tilting axis, the centrifugal force acting during operation of the electric machine assists the movement process, which means that complete movement occurs at higher speeds even at lower torques.

In some examples, the center of gravity of the lever element can lie above the tilting axis when the electric machine is at a standstill. If the center of gravity of the lever is moved radially further outwards than the lever tilting axis, the centrifugal force inhibits the movement process, which means that at higher speeds, complete movement is only achieved at higher torques.

When the electric machine is at a standstill, the center of gravity of the lever may lie in a plane that is spanned by the axis of rotation and the lever tilting axis, whereby an identical movement behavior can be realized for the characteristic curves in motor and generator operation.

Furthermore, in some implementations, when the electric machine is at a standstill, the center of gravity lies outside of the plane that is spanned by the axis of rotation and the lever tilting axis. If the center of gravity thus lies to the left or right of the plane spanned by the axis of rotation and the lever tilting axis, the result is an asymmetrical movement behavior and, in one operating mode, the movement starts at a lower torque than in the other, since the effect of the radial position of the center of gravity is amplified or attenuated at the beginning.

All these constellations of center of gravity of the lever/lever tilting axis can lead to an advantageous movement behavior in terms of machine efficiency over the engine characteristic map for motor and generator operation and can be used individually or in any combination with each other.

Finally, in some examples, the mechanical field-attenuation mechanism has a plurality of lever elements, which are each pivotally arranged in a distributed manner around the circumference of the rotor shaft, whereby a smoother and safer movement of the rotor bodies can be achieved.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an electric machine in a cross-sectional view,

FIG. 2 shows a rotor with a mechanical field-attenuation mechanism in a neutral position in a schematic block diagram,

FIG. 3 shows a rotor with a mechanical field-attenuation mechanism in a first operating position in a schematic block diagram,

FIG. 4 shows a rotor with a mechanical field-attenuation mechanism in a second operating position in a schematic block diagram,

FIG. 5 shows a rotor with a mechanical field-attenuation mechanism in a neutral position in a schematic cross-sectional view,

FIG. 6 shows a rotor with a mechanical field-attenuation mechanism in a second operating position in a schematic cross-sectional view,

FIG. 7 shows a rotor with a mechanical field-attenuation mechanism in a first operating position in a schematic cross-sectional view.

FIG. 8 shows an electric machine in a schematic cross-sectional view,

FIG. 9 shows a rotor in a perspective partial sectional view,

FIG. 10 shows four operating positions of the lever element, each in a detailed cross-sectional view,

FIG. 11 shows a lever element in two perspective views, each of which is isolated,

FIG. 12 shows two cross-sectional views of the rotor,

FIG. 13 shows a rotor with isolated lever elements and securing rings in a perspective view,

FIG. 14 shows two axial sectional views through the rotor,

FIG. 15 shows a first exemplary lever element when the electric machine is at a standstill,

FIG. 16 shows a first exemplary lever element during operation of the electric machine,

FIG. 17 shows a second exemplary lever element when the electric machine is at a standstill,

FIG. 18 shows a third exemplary lever element when the electric machine is at a standstill,

FIG. 19 shows a fourth exemplary lever element when the electric machine is at a standstill.

Like reference symbols in the various drawings indicate like elements.

### DETAILED DESCRIPTION

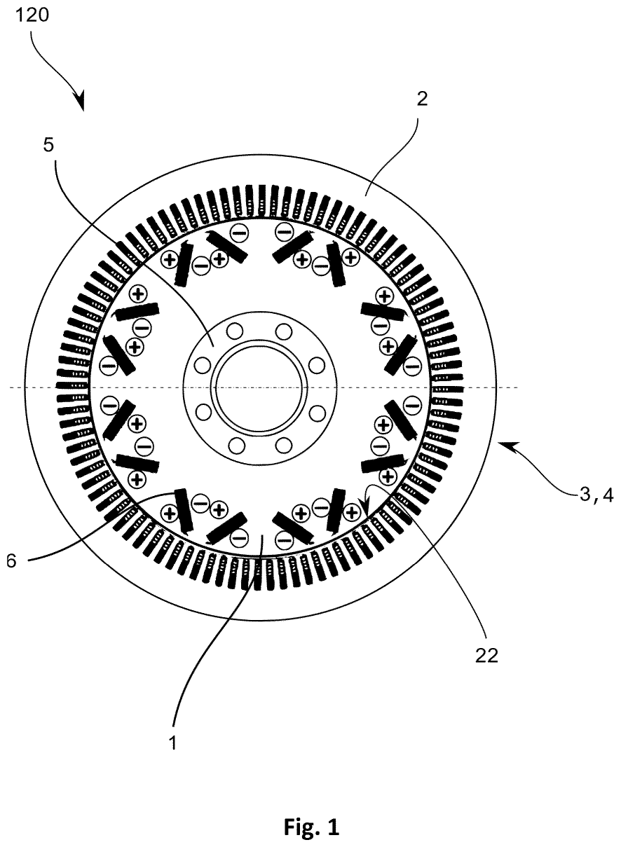

FIG. 1 shows an electric machine 120 configured as a radial flux machine, for use within a drive train of a hybrid or fully electrically powered motor vehicle. The electric machine 120 includes a stator 2 and a rotor 1 separated from the stator 2 by an air gap 22.

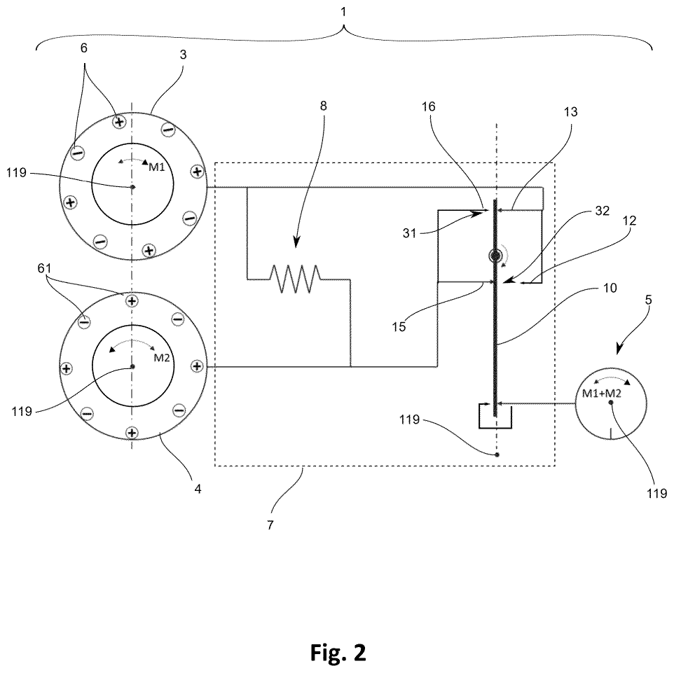

The rotor 1 includes at least a first rotor body 3 with a first group of permanent magnets 6 and a second rotor body 4 with a second group of permanent magnets 61. This is clear from FIGS. 2-7, which show the two rotor bodies 3, 4. The two rotor bodies 3, 4 are essentially formed from identical rotor laminations, where the position and the number of the permanent magnets 6 of the first group and the number of permanent magnets 61 of the second group in the rotor bodies 3, 4 are identical.

The first rotor body 3 and the second rotor body 4 can be rotated relative to one another, counter to the effect of a first torsional stiffness 8, about a common axis of rotation 119 by way of a mechanical field-attenuation mechanism 7.

The field-attenuation mechanism 7 includes a lever element 10 which can be pivoted about a pivot point, where the first rotor body 3 can be coupled to a first lever section 31 and the second rotor body 4 to a second lever section 32 of the lever element 10 and the first lever section 31 and the second lever section 32 are arranged on opposite sides of the lever 10 such that the first rotor body 3 and the second rotor body 4 can be rotated relative to one another in a targeted manner by tilting the lever element 10 for a desired movement of the mechanical field-attenuation mechanism 7, which can also be clearly seen from the combination of FIGS. 2-4 and which will be explained in more detail below.

The field-attenuation mechanism 7 uses the lever element 10 at at least two circumferential locations of the rotor bodies 3, 4 within the rotor 1, also referred to as lever contact sections 12, 13, 15, 16, for transmitting the partial torques of the two rotor bodies 3, 4 to the rotor shaft 5 while simultaneously providing a torsional stiffness 8 between the rotor bodies 3, 4, which can also be clearly seen from the block diagrams in FIGS. 2-4. The lever element 10 has three regions at different distances from the axis of rotation 119 of the rotor 1, in which it is in contact with the two rotor bodies 3, 4 as the two inputs for the torque and the rotor shaft 5 as the output for the torque. Here, the three regions of the lever element 10 are the first lever section 31, the second lever section 32, and the unspecified contact section at the radially inner end of the lever element 10 to the rotor shaft 5.

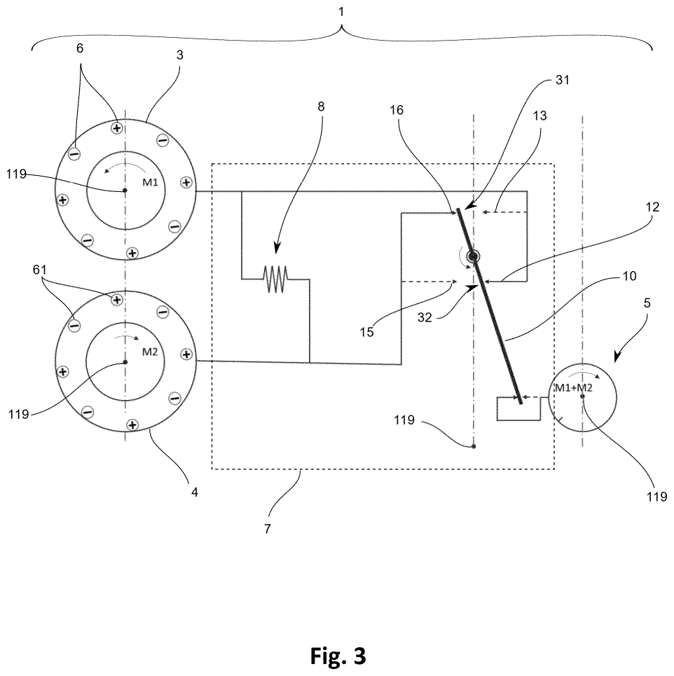

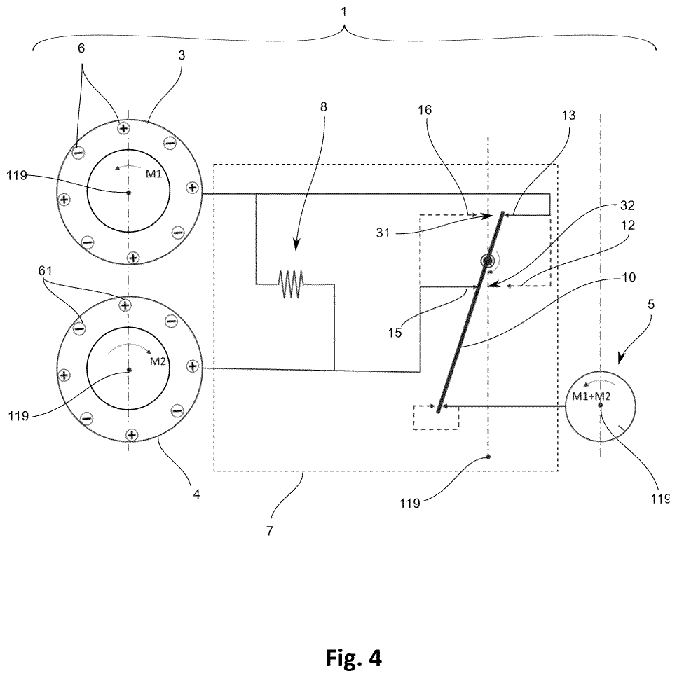

Via these defined contact regions of the first and second lever sections 31, 32, the partial torques of the two rotor bodies 3, 4 act on the lever element 10 via the lever contact sections 12, 13, 15, 16 in such a way that the sum is transmitted to the rotor shaft 5 via the unspecified contact section at the radially inner end of the lever element 10 and at the same time, by tilting the lever element 10, the two rotor bodies 3, 4 are rotated via the lever contact sections 12, 13, 15, 16 against the torsional stiffness 8 that prevails between them into the position with a full magnetic field with aligned magnetic poles, as shown in FIGS. 3-4. With the lever element 10, the partial torques, which actually point in the wrong direction for this process, are converted into the target direction.

The torsional stiffness 8 is symbolically shown in FIGS. 2-4 with compression springs, which are located, for example, in spring windows of both rotor bodies 3, 4. However, the torsional stiffness 8 can also be formed in any other known way.

FIG. 2 shows the field-attenuation mechanism 7 initially in its neutral position. The field-attenuation mechanism 7 is in a field-attenuated position here, with the magnetic poles of the first group of permanent magnets 6 not aligned with the second group of permanent magnets 61, which can be easily understood from the rotational angle position of the two rotor bodies 3, 4 in FIG. 2. In this case, the total torque is lower than a minimum torque that is required to allow the rotor bodies 3, 4 to begin to move relative to one another against the possibly biased torsional stiffness 8. The characteristic curve of the torsional stiffness 8 is selected such that when a specified minimum torque is exceeded, the field-attenuation mechanism 7 begins to move from the position with maximum field attenuation and when a specified higher torque is reached and exceeded, the complete movement to the position with a full magnetic field has been completed, as is shown, for example, for a motor operation of the electric machine 120 in FIG. 3.

The first partial torque M1 is transmitted via the lever contact sections 12, 13 of the first rotor body 3 depending on the direction of the total torque, where the first lever contact section 12 of the first rotor body 3 is arranged to be radially inwardly offset from the second lever contact section 13. Analogously, the second partial torque M2 of the second rotor body 4 is transmitted to the lever element 10 via the lever contact sections 15, 16, depending on the direction of the total torque. The first lever contact section 15 of the second rotor body 4 is arranged to be radially inwardly offset from the second lever contact section 16.

If the direction of the total torque changes, for example by changing from a motor to a generator operation of the electric machine 120, the lever sections 31, 32 of the lever element 10 can change sides and in both operating states the identical relative rotation takes place between the rotor bodies 3, 4 in order to generate an attenuated or full magnetic field, as shown in FIGS. 3-4.

In FIG. 3, the mechanical field-attenuation mechanism 7 is in an operating position with a full magnetic field with aligned magnetic poles of the permanent magnets 6, 61 and the lever element 10 in a tilted extreme position. In this case, for example, a total torque when driving in motor operation is greater than a minimum torque for the entire movement against the torsional stiffness 8.

FIG. 4 shows the mechanical field-attenuation mechanism 7 in position with a full magnetic field with aligned magnetic poles of the permanent magnets 6, 61 and the lever element 10 in an oppositely tilted extreme position with oppositely acting torque. In this case, for example, a total torque during recuperation in generator operation of the electric machine 120 is greater than a minimum torque for the entire movement against the torsional stiffness 8.

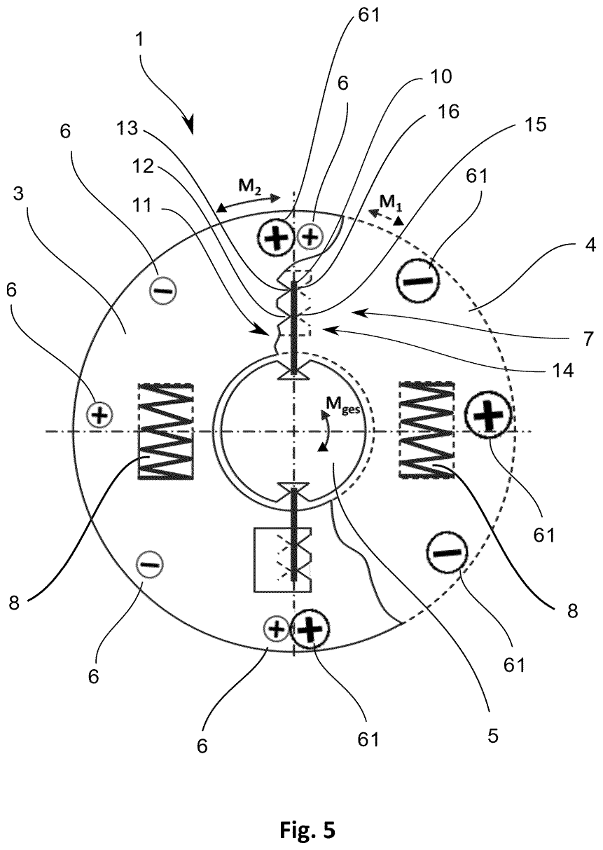

As can be seen from FIGS. 5-7, which outline a possible design of the principle shown in FIGS. 2-4, the rotor shaft 5 is coupled coaxially within the first rotor body 3 and the second rotor body 4 via the lever element 10 in a torque-transmitting manner to the first rotor body 3 and the second rotor body 4, where the lever element 10 is pivotably arranged on the rotor shaft 5.

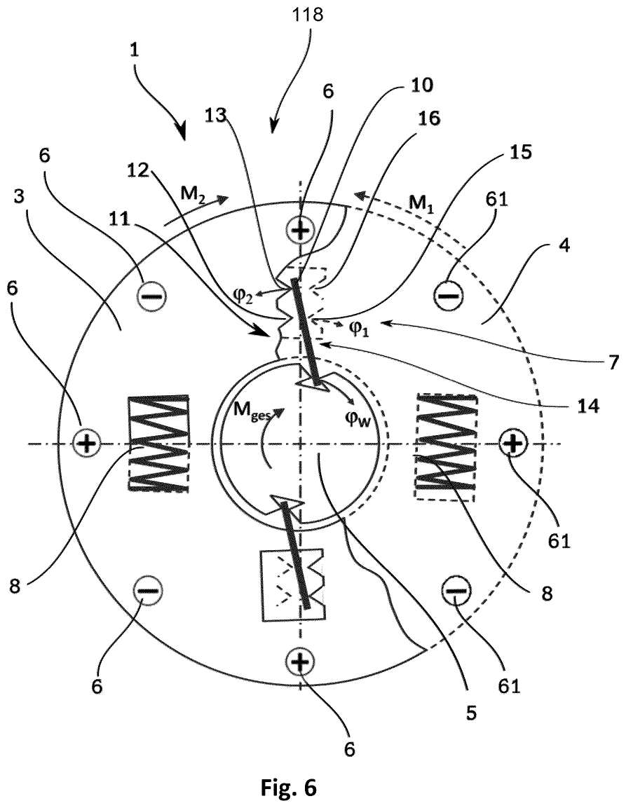

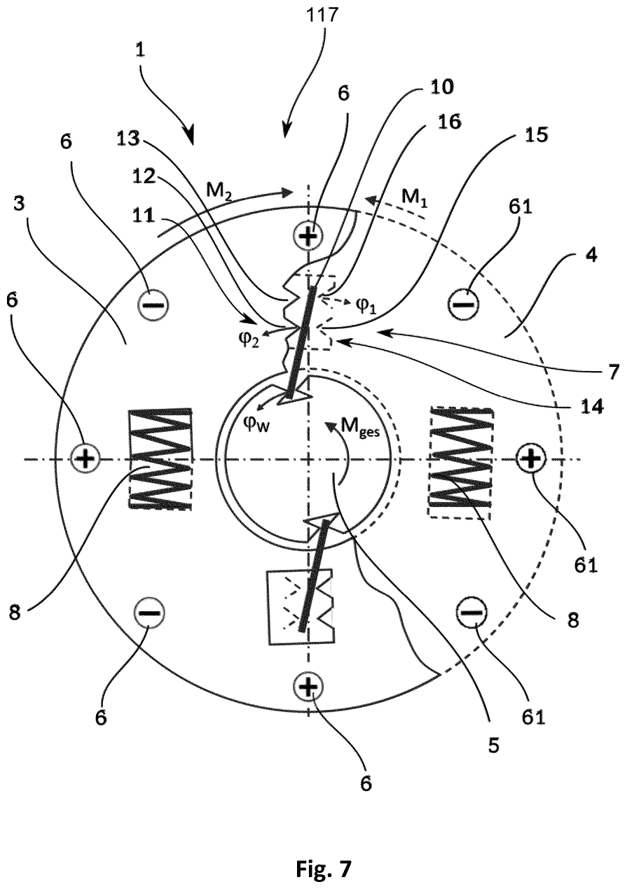

As shown in FIGS. 5-7, the lever element 10 extends in the radial direction into a first lever window 11 of the first rotor body 3 shown in a partial sectional view, wherein the first lever window 11 has a first lever contact section 12 and a second lever contact section 13 radially spaced apart therefrom, which is indicated by a solid line. The lever element 10 further extends in the radial direction into a second lever window 14 of the second rotor body 3. This second lever window 14 has a first lever contact section 15 and a second lever contact section 16 radially spaced apart therefrom, which is shown by a dashed line. In a first operating position 117 which is shown in FIG. 7, the lever element 10 bears against the first lever contact section 12 of the first lever window 11 and against the second lever contact section 16 of the second lever window 14, and in a second operating position 118 which is shown in FIG. 6, against the second lever contact section 13 of the first lever window 11 and against the first lever contact section 15 of the second lever window 14.

The first lever contact section 12 is arranged to be radially below the second lever contact section 13 of the first lever window 11 and the first lever contact section 15 is arranged to be radially below the second lever contact section 16 of the second lever window 14. At the first lever contact section 12 of the first lever window 11 and at the first lever contact section 15 of the second lever window 14, a larger torque is transmitted via the first lever element 10 than at the second lever contact section 13 of the first lever window 11 and the second lever contact section 16 of the second lever window 14.

The torsional stiffness 8 is designed as a spring element in FIGS. 5-7, for example as a compression spring or arc spring, the characteristic curve of which exhibits a bias torque. Here, too, the characteristic curve of the torsional stiffness 8 is selected such that when a specified minimum torque is exceeded, the first rotor body 3 and the second rotor body 4 begin to rotate relative to one another from a position with maximum field attenuation and, when a specified maximum torque is reached and/or exceeded, they have completed a rotation relative to one another into a position with a full magnetic field.

In FIGS. 5-7, the field-attenuation mechanism 7 has two opposing, essentially identical lever elements 10, which are each pivotally arranged in a distributed manner around the circumference of the rotor shaft 5.

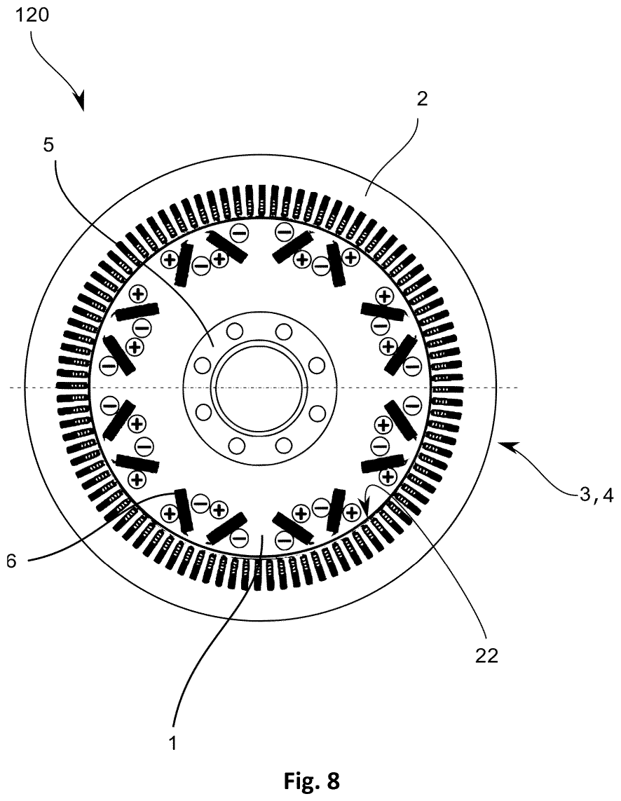

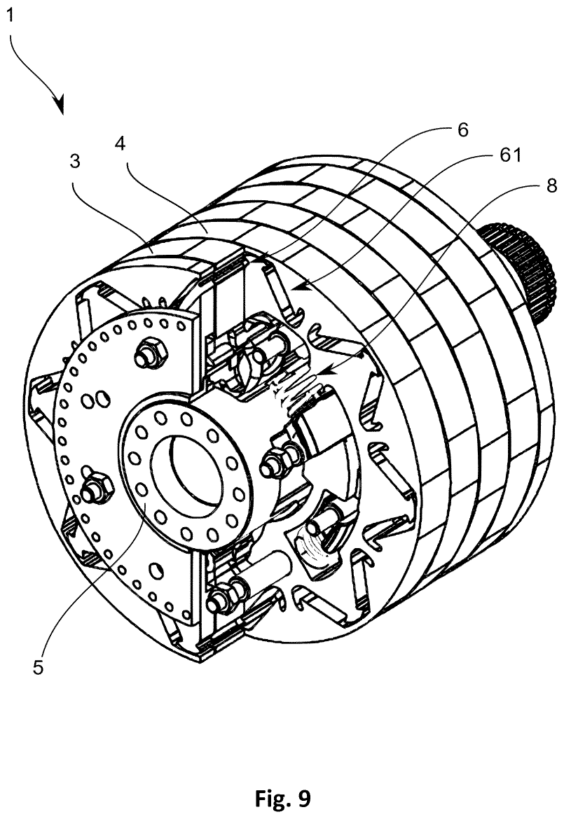

FIG. 8 shows an electric machine 120, for use within a drive train of a hybrid or fully electrically powered motor vehicle, having a stator 2 and a rotor 1 separated from the stator 2 by an air gap 22. The rotor 1 has a first rotor body 3 with a first group of permanent magnets 6 and a second rotor body 4 with a second group of permanent magnets 61, which is axially spaced apart from the first rotor body 3, as can be clearly seen from FIG. 9.

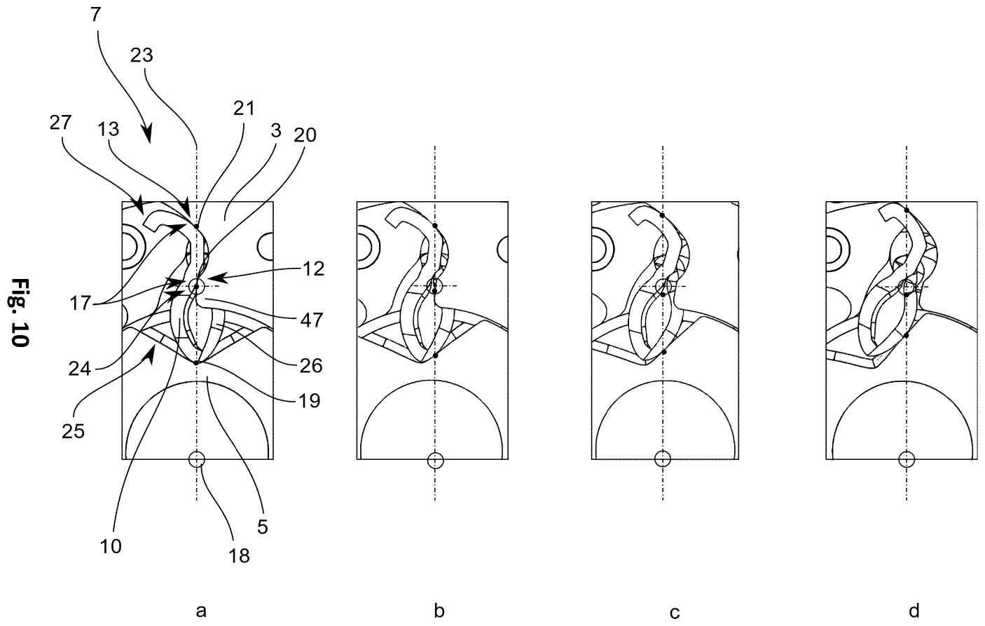

Within the first rotor body 3 and the second rotor body 4, a rotor shaft 5 is coaxially coupled to the first rotor body 3 and the second rotor body 4 in a torque-transmitting manner. The first rotor body 3 is rotatably mounted on the rotor shaft 5 relative to the second rotor body 4 by way of a mechanical field-attenuation mechanism 7, counter to the effect of a first torsional stiffness 8, which is designed as a compression spring or arc spring. In order to transmit the partial torques of the two rotor bodies 3, 4 to the rotor shaft 5, a lever element 10 is used at at least two circumferential points within the rotor 1, with the simultaneous effect of the torsional stiffness 8 between the rotor bodies 3, 4. The mechanical field-attenuation mechanism 7 is explained in more detail below with reference to FIG. 10.

It can be seen from FIG. 10 that the contours 17 of the lever element 10 which are in contact with the lever contact sections 12, 13, 15, 16 are designed such that in each operating position of the mechanical field-attenuation mechanism 7 over its entire movement path in sections perpendicular to the rotational axis 18 of the rotor 1, all contact points 19, 20, 21 between the rotor bodies 3, 4 and the lever element 10 are arranged on a straight connecting line 23 between the tilting axis 24 of the lever element 10 and the rotational axis 18 of the rotor 1.

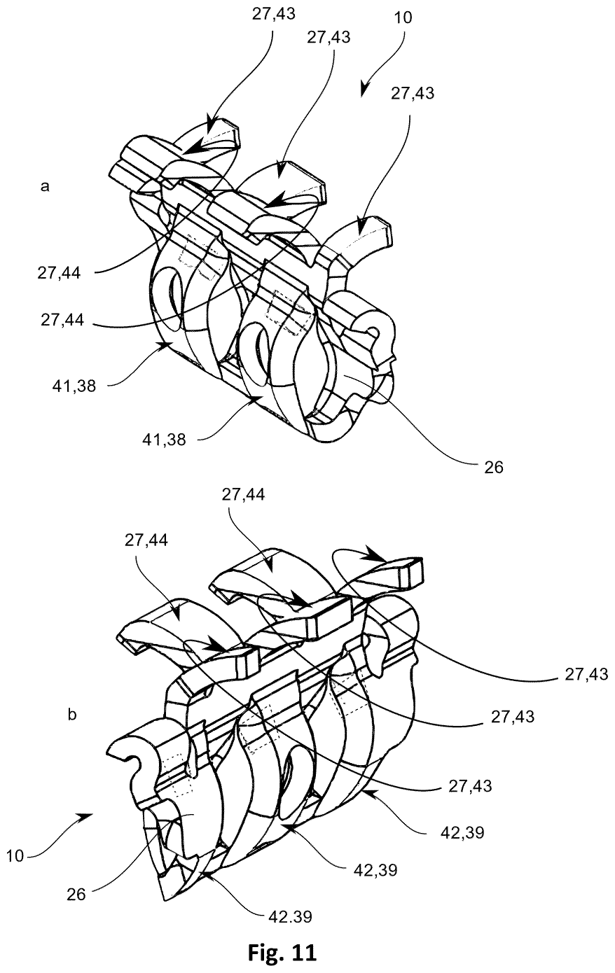

The lever element 10 includes an ovoid base body 26 is received in a V-shaped groove 25 directed radially inward and extending axially through the rotor shaft 5. The ovoid, i.e., egg-shaped, shape of the base body 26 can also be clearly seen in FIG. 4. The ovoid base body 26 rolls in the V-shaped groove 25 during operation of the mechanical field-attenuation mechanism 7. To illustrate these kinematics, FIG. 3 shows four operating positions of the lever element 10, where the rotor shaft 5 moves counterclockwise relative to the rotor body 3. For better visibility of the kinematic process during the movement of the field-attenuation mechanism 7, the reference symbols in the images marked b, c, d in FIG. 11 have been omitted.

It can be clearly seen from the illustrations in FIG. 11 that the corresponding design of the lever element 10, the lever contact sections 12, 13, 15, 16, and the V-shaped groove 25 result in a slip-free contact between the lever element 10, the rotor bodies 3, 4, and the rotor shaft 5. The lever element 10, the lever contact sections 12, 13, 15, 16 and the V-shaped groove are geometrically designed in such a way that their contours roll on one another during the tilting of the lever element 10 about a tilting axis 24 and the rotation of the rotor bodies 3, 4 or the rotor shaft 5 about the rotational axis 18 of the rotor 1.

For this purpose, the contours 17 of the lever element 10 are designed in such a way that in every position of the mechanical field-attenuation mechanism over the entire intended movement, viewed in sections perpendicular to the rotational axis 18, all contact points 19, 20, 21 between the rotor bodies 3, 4 and the lever element 10 lie on a straight connecting line 23 between the tilting axis 24 of the lever element 10 and the rotational axis 18 of the rotor 1.

The lever element thus has three contact regions radially spaced apart from one another by the contact points 19, 20, 21, which are located at different distances from the axis of rotation 18 of the rotor 1, with which it is in axial contact with the two rotor bodies 3, 4 as the two inputs for the torque and the rotor shaft 5 as the output for the torque.

The partial torques of the two rotor bodies 3, 4 act on the lever element 10 via the defined contact regions of the contact points 20, 21 in such a way that the sum is transferred to the rotor shaft 5 via the contact region of the contact point 19 and at the same time, by tilting the lever element, the two rotor bodies 3, 4 are rotated against the torsional stiffness 8 that prevails between them into the position with a full magnetic field with aligned magnetic poles of the permanent magnets 6, 61, which can be easily understood from the various operating positions as shown in FIG. 11.

With the lever element 10, the partial torques, which actually point in the wrong direction for this process, are converted into the target direction. The decisive factor here is that the larger of the two partial torques, which determines the direction of the total torque, acts radially further inside the lever element than the smaller of the two partial torques.

The rotor bodies 3, 4 provide lever contact sections 12, 13, 15, 16 at both distances to the rotational axis 18 for contact with the lever element 10 at the contact points 20, 21, which can be clearly seen in FIG. 5. If the direction of the total torque changes during motor and generator operation, the contact of the contact points 20, 21 on the lever element 10 can change sides and in both operating states the identical relative rotation takes place between the rotor bodies 4, 4 to generate an attenuated or full magnetic field.

The characteristic curve of the torsional stiffness 8 is selected such that when a specified minimum torque is exceeded, the mechanical field-attenuation mechanism 7 begins to move from the position with the magnetic field at its maximally attenuated level, and when a specified higher torque is reached and exceeded, the entire movement to the position with the full magnetic field is completed. The characteristic curve for the torsional stiffness 8 can have a bias torque for this purpose.

The lever element 10, in its non-tilted neutral position, which is shown in the illustration a of FIG. 10, forms a stop for the position with a maximally attenuated magnetic field with its then bilateral contacts at the contact points 20, 21 to the rotor bodies 3, 4 at their lever contact sections 12, 13, 15, 16 against a magnetic repulsion torque between the rotor bodies 3, 4 and against a bias torque of the torsional stiffness 8. As shown in FIG. 5, stop teeth 35, 36 acting in the circumferential direction are formed between the rotor discs 29, 30 of the rotor bodies 3, 4 and the rotor shaft 5, which define the rotary end positions of the rotor shaft relative to the rotor discs 29, 30 or the rotor bodies 3, 4. If the torque for this position is exceeded, the lever mechanism is bypassed by the stop teeth and the increased torque is transmitted directly from the rotor bodies 3, 4 to the rotor shaft 5.

The lever element 10 is shown in two isolated perspective views in FIG. 11. It can be clearly seen from these illustrations that arcuate claws 27 extending radially outwards are formed on the ovoid base body 26 for engagement with the radially outer lever contact sections 13, 16. Here, the circumferential orientations of the arcuate claws 27 alternate in the axial direction. The base body 26 is hollow and also has convex arc sections 38, 39 arranged alternately in the axial direction, where one group of arc sections 38 is assigned to the first rotor body 3 and the other group of arc sections 39 is assigned to the second rotor body 4.

The radially inner contact point 19 with the lever contact section 12, 15 of the rotor bodies 3, 4 is located on the radially inner contact surfaces 41, 42 of the arc sections 38, 39 of the lever element 10. The radially outer contact surfaces 43, 44 on the arcuate claws 27 of the lever element 10 provide the contact point 21 with the rotor bodies 3, 4. Radially therebetween, the contact surfaces 45, 46 are formed on the ovoid base body 26, which form the contact point 20 with the rotor bodies 3, 4. This can be clearly seen again when comparing FIG. 4 with FIG. 10.

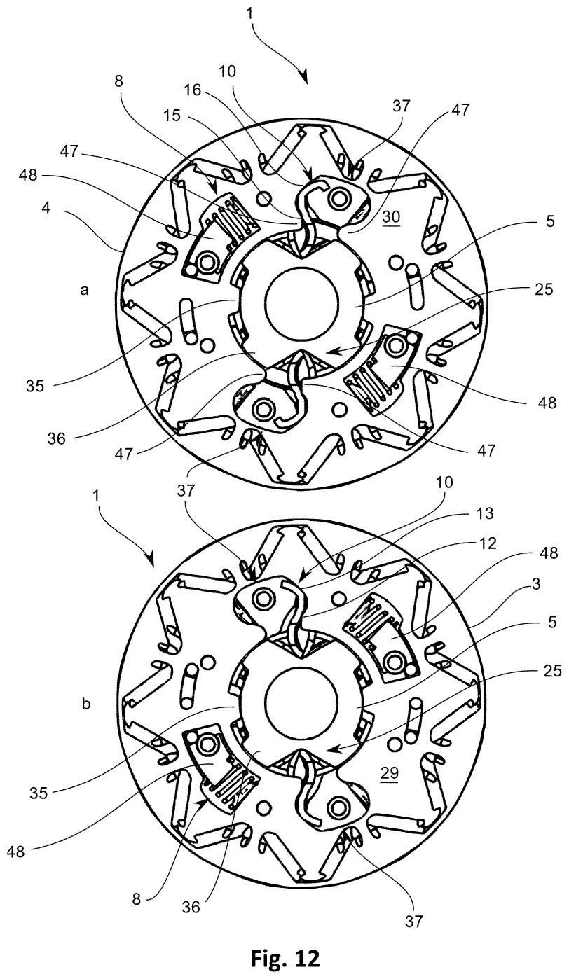

The claws 27, as well as a section of the ovoid base body 26, engage radially in pockets 37 provided for this purpose in the rotor bodies 3, 4 in order to make contact therewith, which can be particularly clearly seen in FIG. 12. The pockets 37 have a mushroom cloud-like contour with opening shoulders 47 circumferentially directed inwards on the radially inner section. The lever contact section 12, 15 of the rotor bodies 3, 4 is formed on these opening shoulders 47 of the pockets 37. The radially outer lever contact sections 13, 16 are formed in the pockets 37.

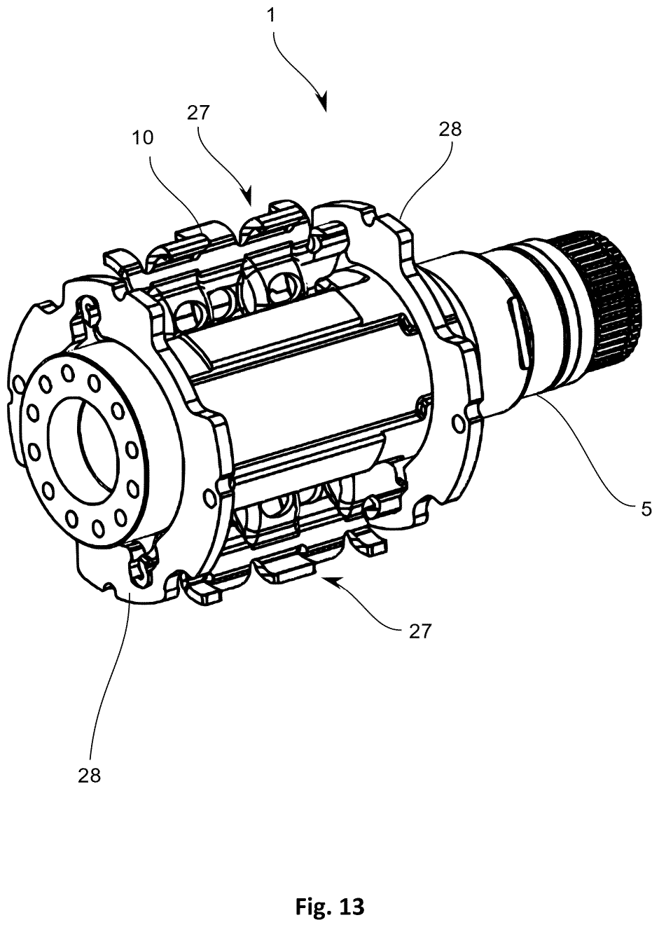

The lever element 10 is secured radially by a securing ring 28 which can be rotated relative to and coaxially with the rotor 1, as shown in FIG. 13. This supports the centrifugal force of the lever element 10 in the rotor 1 and secures its radial position. In order to minimize friction at the support points, the contours of the contacting surfaces between the lever element 10 and the securing ring 28 can also be designed such that they roll against each other. For this purpose, the axially outer claws of the lever element 10 are provided, which are not shown in more detail and have a design that differs from the arcuate claws 27, which can also be clearly seen in FIG. 11. These axially outer claws, which are not shown further, engage in pockets provided for this purpose in the securing rings 28.

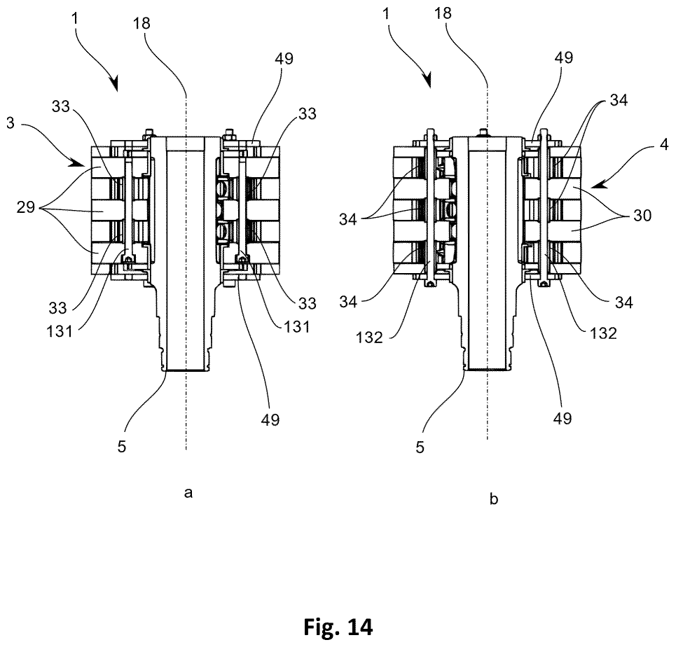

The first rotor body 3 includes a plurality of rotor discs 29, which are arranged in the axial direction alternating with rotor discs 30 of the second rotor body 4. The rotor discs 29 of the first rotor body 3 are connected to form a structural unit via first connecting means 131 (i.e., a first connector 131) extending axially in parallel to the rotational axis 18 of the rotor 1, and the rotor discs 30 of the second rotor body 4 are connected to form a structural unit via second connecting means 132 (i.e., a second connector 132) extending axially in parallel to the rotational axis 18 of the rotor 1, which can be clearly seen in FIG. 14. A spacer sleeve 33 is arranged on the first connecting means 131 between adjacent rotor discs 29 of the first rotor body 3, and a spacer sleeve 34 is arranged on the second connecting means 132 between adjacent rotor discs 30 of the second rotor body 4.

The connecting means 131, 132 carry guide elements 48 for one end of a torsional stiffness 8 acting in the circumferential direction on associated spacer sleeves 33, 34. The other end of the rotor rests in an unspecified recess of the respective rotor disc of the rotor body 3, 4. Via the torsional stiffness 8, the guide elements 48, the spacer sleeves 33, 34, and finally the connecting means 131, 132, a torsional stiffness 8 is formed from both rotor bodies 3, 4 to the respective other rotor body 3, 4, in such a way that the two torsional stiffnesses 8 interact in a parallel circuit in the direction of the relative rotation, which means a stronger magnetic field. The two rotor bodies 3, 4 are each mounted on the front rotor discs with rolling or plain bearings on the rotor shaft 5. The rotor 1 can be balanced on two front-side balancing discs 49, which are part of the first rotor body 3.

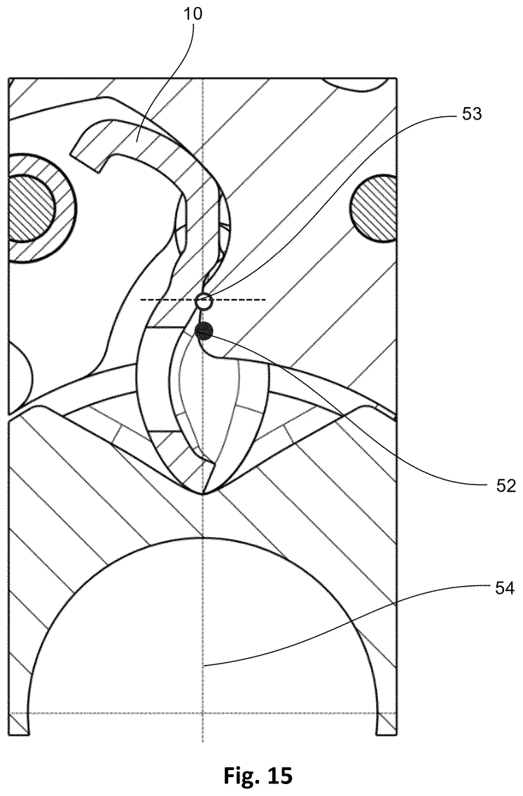

FIGS. 15-19 show a field-attenuation mechanism 7 including a lever element 10 with a center of gravity 52 that is pivotable about a tilting axis 53. This tilting axis 53, provided with the reference symbol 53 in FIGS. 15-19, corresponds to the tilting axis referenced with the reference symbol 24 in FIG. 10. As in the previous figures, the first rotor body 3 can be coupled to a first lever section 31 and the second rotor body 4 can be coupled to a second lever section 32 of the lever element 10, where the first lever section 31 and the second lever section 32 are arranged on opposite sides of the lever 10 such that the first rotor body 3 and the second rotor body 4 can be rotated relative to one another in a targeted manner by tilting the lever element 10 for a desired movement of the mechanical field-attenuation mechanism 7. In this regard, the center of gravity 52 and the tilting axis 53 of the lever element 10 are spaced apart from one another when the electric machine 120 is at a standstill.

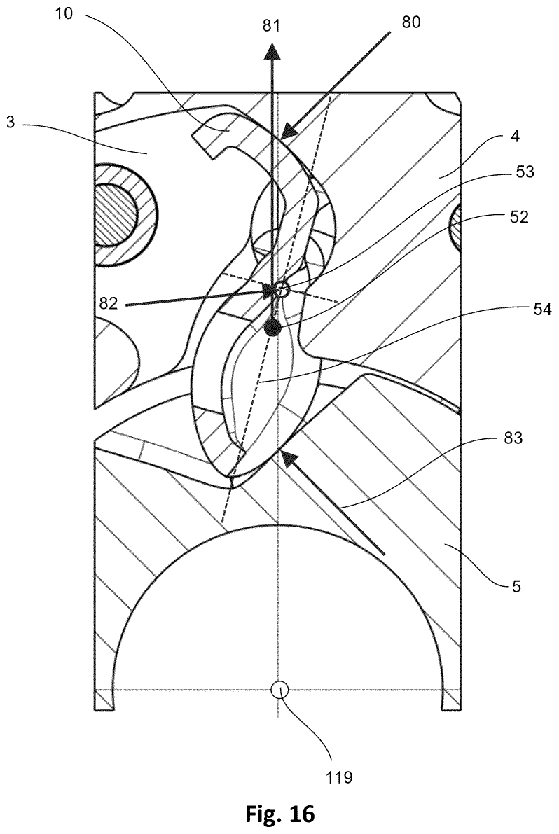

The position of the center of gravity 52 and the lever tilting axis 53 may be determined by distributing the material within the lever element 10 in a suitable way, such as by way of shaping, adding mass or removing material. The decisive factor for the tilting of the lever element 10 and thus for the strength of the magnetic field in the associated position of the rotor body 3, 4 is the balance of forces and torques at the lever element 10, as shown in FIG. 16. The following factors influence this balance of forces and torques:
the forces 80 and 82 resulting from the torsional stiffness 8 between the rotor bodies 3, 4 and the electromagnetic partial torques on the rotor bodies 3, 4 due to the stator current supply at the contact points of the lever element 10 to the rotor bodies 3, 4;
the force 83 arising from the transmission of the total torque at the contact point of the lever element 10 to the rotor shaft 5,
the speed-dependent centrifugal force 81 in the center of gravity 52, and
as lever arms, the distances of the lines of action of all the forces mentioned to a fixed lever tilting axis 53.

By adjusting the position of the center of gravity 52 and the lever tilting axis 53, it is possible to account for fundamentally different movement behaviors via torque and speed in connection with the other influences mentioned, which will be explained in more detail below.

If the movement behavior is to depend only on the torque, the center of gravity 52 and the lever tilting axis 53 must coincide in their axial projection. If the center of gravity 52 is radially further inwards than the lever tilting axis 53, the centrifugal force 81 assists the movement process, which means that complete movement occurs at higher speeds even at lower torques. This can be seen in FIG. 15, where the center of gravity 52 of the lever element 10 lies below the tilting axis 53 when the electric machine 120 is at a standstill.

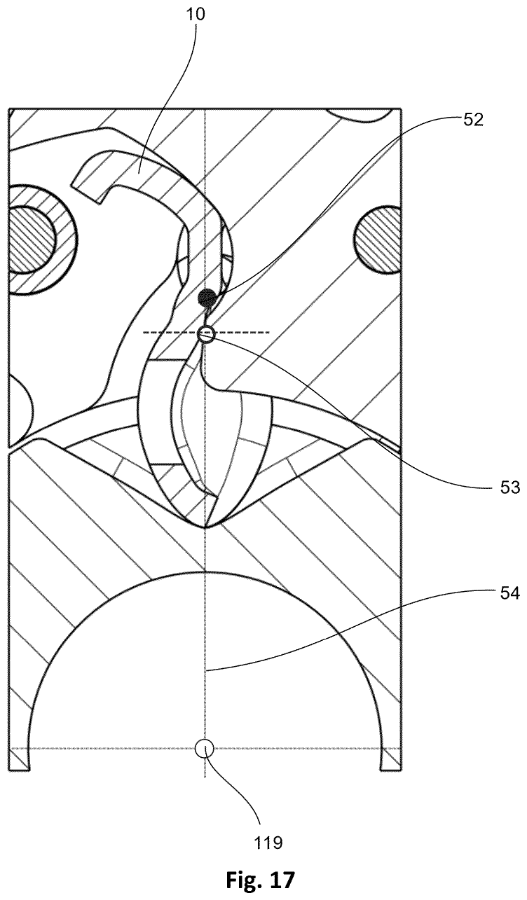

Conversely, if the center of gravity 52 is radially further outwards than the lever tilting axis 53, the centrifugal force 81 inhibits the movement process, which means that at higher speeds, complete movement is only achieved at higher torques. This configuration is shown in FIG. 17, in which the center of gravity 52 of the lever element 10 lies above the tilting axis 53 when the electric machine 120 is at a standstill.

FIGS. 15 and 17 have shown the exemplary lever element 10 in which, when the electric machine 120 is at a standstill, the center of gravity 52 lies in a plane 54 that is spanned by the axis of rotation 119 and the lever tilting axis 53. This allows for an identical movement behavior for the characteristic curves in motor and generator operation.

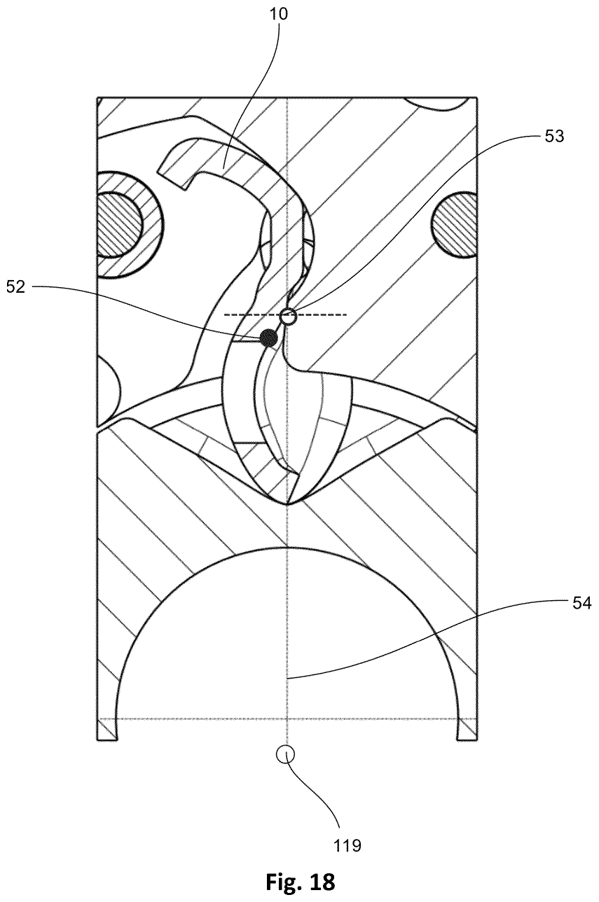

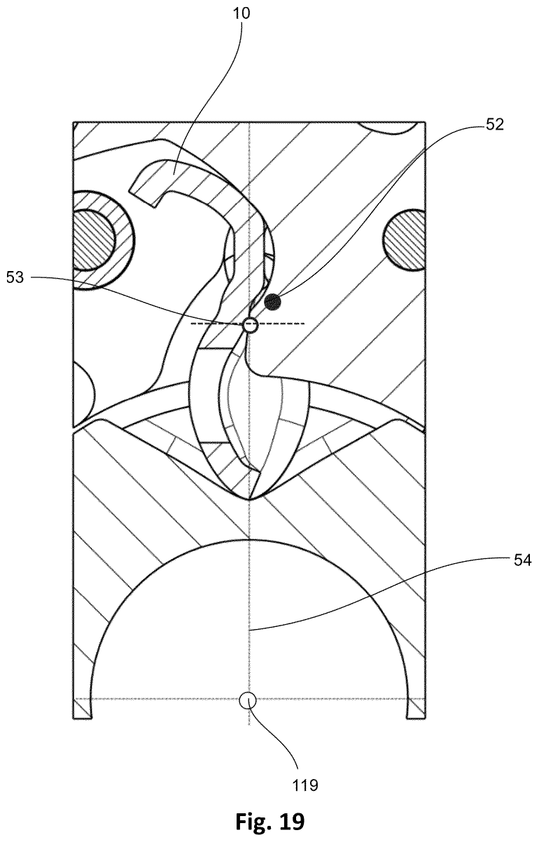

FIGS. 18-19 show variants in which, when the electric machine 120 is at a standstill, the center of gravity 52 lies outside of the plane 54 that is spanned by the axis of rotation 119 and the lever tilting axis 53. If the center of gravity lies to the left or right of the plane, the result is an asymmetrical movement behavior and, in one operating mode, the movement starts at a lower torque than in the other, since the effect of the radial position of the center of gravity is amplified or attenuated at the beginning.

A number of implementations have been described. The above description is therefore not to be regarded as limiting, but rather as illustrative. The following claims are to be understood as meaning that a stated feature is present in at least one example of the disclosure. This does not exclude the presence of further features. Where the claims and the above description define ‘first’ and ‘second’ features, this designation serves to distinguish between two features of the same type without defining an order of precedence.

### REFERENCE NUMERALS

1 Rotor
2 Stator
3 First rotor body
4 Second rotor body
5 Rotor shaft
6 First group of permanent magnets
7 Field-attenuation mechanism
8 Torsional stiffness
10 Lever element
11 First lever window
12 Lever contact section
13 Lever contact section
14 Second lever window
15 Lever contact section
16 Lever contact section
17 Contours
18 Rotational axis
19 Contact point
20 Contact point
21 Contact point
22 Air gap
23 Connecting line
24 Tilting axis
25 Groove
26 Base body
27 Claws
28 Securing ring
29 Rotor discs
30 Rotor discs
31 First lever section
32 Second lever section
33 Spacer sleeve
34 Spacer sleeve
35 Stop teeth
36 Stop teeth
37 Pockets
38 Arc section
39 Arc section
41 Contact surface
42 Contact surface
43 Contact surface
44 Contact surface
45 Contact surface
46 Contact surface
47 Opening shoulder
48 Guide elements
49 Balancing discs
52 Center of gravity
53 Tilting axis
54 Plane
61 Second group of permanent magnets
80 Force
81 Centrifugal force
83 Force
117 Operating position
118 Operating position
119 Axis of rotation
120 Electric machine
131 Connecting means
132 Connecting means

1. An electric machine for use within a drive train of a hybrid or fully electrically powered motor vehicle, the electric machine comprising:
a stator; and
a rotor separated from the stator by an air gap, the rotor has at least a first rotor body with a first group of permanent magnets and a second rotor body with a second group of permanent magnets, the first rotor body and the second rotor body be are rotated relative to one another, counter to an effect of a first torsional stiffness, about a common axis of rotation by a mechanical field-attenuation mechanism,
wherein the field-attenuation mechanism comprises a lever element with a center of gravity, which is pivoted about a tilting axis, wherein the first rotor body is coupled to a first lever section and the second rotor body is coupled to a second lever section of the lever element and the first lever section and the second lever section are arranged on opposite sides of the lever such that the first rotor body and the second rotor body is rotated relative to one another in a targeted manner by tilting the lever element for a desired movement of the mechanical field-attenuation mechanism, wherein the center of gravity and the tilting axis of the lever element are spaced apart from one another when the electric machine is at a standstill.

2. The electric machine according of claim 1, wherein the center of gravity of the lever element lies below the tilting axis when the electric machine is at a standstill.

3. The electric machine of claim 1, wherein the center of gravity of the lever element lies above the tilting axis when the electric machine is at a standstill.

4. The electric machine of claim 1, wherein when the electric machine is at a standstill, the center of gravity lies in a plane that is spanned by the axis of rotation and the lever tilting axis.

5. The electric machine according to claim 1, wherein when the electric machine is at a standstill, the center of gravity lies outside of a plane that is spanned by the axis of rotation and the lever tilting axis.

6. An electric machine supported by a drive train of a hybrid or fully electrically powered motor vehicle, the electric machine comprising:
a stator;
a rotor separated from the stator by an air gap, the rotor has at least a first rotor body with a first group of permanent magnets and a second rotor body with a second group of permanent magnets;
a mechanical field-attenuation mechanism comprising a lever element with a center of gravity, which is pivoted about a tilting axis, wherein the first rotor body and the second rotor body are rotated relative to one another, counter to an effect of a first torsional stiffness, about a common axis of rotation by the mechanical field-attenuation mechanism, the lever element comprising a first lever section and a second lever section arranged on opposite sides of the lever;
wherein the first rotor body is coupled to the first lever section and the second rotor body is coupled to the second lever section such that the first rotor body and the second rotor body are rotated relative to one another in a targeted manner by tilting the lever element for a desired movement of the mechanical field-attenuation mechanism, wherein the center of gravity and the tilting axis of the lever element are spaced apart from one another when the electric machine is at a standstill.

7. The electric machine of claim 1, wherein the center of gravity of the lever element is below the tilting axis when the electric machine is at a standstill.

8. The electric machine of claim 1, wherein the center of gravity of the lever element is above the tilting axis when the electric machine is at a standstill.

9. The electric machine of claim 1, wherein when the electric machine is at a standstill, the center of gravity is in a plane that is spanned by the axis of rotation and the lever tilting axis.

10. The electric machine of claim 1, wherein when the electric machine is at a standstill, the center of gravity is outside of a plane that is spanned by the axis of rotation and the lever tilting axis.
